(19) United States
(12) Patent Application Publication
(10) Pub. No.: US 2024/0170748 A1
(43) Pub. Date: May 23, 2024

(54) BATTERY CELL COMPRISING THERMOCHROMIC MEMBER

(71) Applicant: SK ON CO., LTD., Seoul (KR)

(72) Inventors: John Cronin, Jericho, VT (US); Byeong Hyeon PARK, Daejeon (KR); Soo Min PARK, Daejeon (KR); Hyung Ju PAIK, Daejeon (KR); Hae Ryong JEON, Daejeon (KR)

(21) Appl. No.: 18/352,243

(22) Filed: Jul. 14, 2023

Related U.S. Application Data
(60) Provisional application No. 63/427,677, filed on Nov. 23, 2022.

(51) Int. Cl. H01M 10/48; H01M 10/04; H01M 50/308

(52) U.S. Cl. CPC H01M 10/488; H01M 10/0431; H01M 50/308; H01M 2200/10

(57) ABSTRACT

A battery cell is provided. The battery cell includes an electrode assembly; a housing including a case accommodating the electrode assembly and a cap assembly covering the case; and a thermochromic member thermally connected to the housing. The thermochromic member may include a thermochromic region configured to change color based on temperature.

### CROSS-REFERENCE TO RELATED APPLICATION(S)

This patent document claims the benefits of U.S. Provisional Patent Application No. 63/427,677 filed on Nov. 23, 2022, the disclosure of which is incorporated herein by reference in its entirety.

### TECHNICAL FIELD

The present disclosure relates to a battery cell including a thermochromic member. More specifically, present disclosure relates to a battery cell including a thermochromic member for improving stability of a battery cell and increasing operator convenience when replacing the battery cell.

### BACKGROUND

When a battery cell is overheated, the lifespan of the battery cell may decrease and performance of the battery cell may be degraded. Overheating of the battery cell may cause failure of the battery cell or a battery device.

In addition, when battery cells are mounted in a battery device (e.g., a battery module or a battery pack), all battery cells of the battery device may need to be replaced because a battery cell having an error may not be able to be identified.

A battery cell in which an event (e.g., overheating) occurs in a battery device may be detected or a battery cell may be monitored using test equipment, such as a thermal imaging camera.

### SUMMARY

Present disclosure may be implemented in some embodiments to inspect or monitor the occurrence of an event (e.g., overheating) during an operation of a battery cell by visually displaying a temperature of the battery cell without additional measuring equipment (e.g., a thermal imaging camera).

The present disclosure may be implemented in some embodiments to improve convenience in replacing a cell in which an event occurs in a battery device (e.g., a battery module or a battery pack) including a plurality of battery cells.

In the disclosure, a battery cell may include an electrode assembly, a housing including a case accommodating the electrode assembly and a cap assembly covering the case, and a thermochromic member thermally connected to the housing. Wherein the thermochromic member may include a thermochromic region configured to change color based on temperature.

According to an embodiment, the cap assembly may include a venting portion for discharging gas generated in the electrode assembly to the outside of the battery cell. The thermochromic member may cover at least a portion of the venting portion.

According to an embodiment, the thermochromic member may include a display region coated with a thermochromic dye in a designated shape or letter shape.

According to an embodiment, the thermochromic member may cover at least a portion of a side surface of the case.

According to an embodiment, the thermochromic member may include a first thermochromic region and a second thermochromic region spaced apart from the first thermochromic region.

According to an embodiment, the first thermochromic region may be configured to change color at a first activation temperature, and the second thermochromic region may be configured to change color at a second activation temperature, lower than the first activation temperature.

According to an embodiment, the first thermochromic region may be closer to the cap assembly than the second thermochromic region.

According to an embodiment, the battery cell may further include: a conductive member including a first end portion attached to the housing and a second end portion exposed to the outside of the battery cell. The thermochromic member may be attached on the second end portion of the conductive member.

According to an embodiment, the cap assembly may include a through-hole. At least a portion of the conductive member may pass through the through-hole to be exposed to the outside of the battery cell.

According to an embodiment, the conductive member may include a first conductive member and a second conductive member spaced apart from the first conductive member. The through-hole may include a first through-hole accommodating the first conductive member and a second through-hole accommodating the second conductive member.

According to an embodiment, the conductive member may include a conductive foil connecting the first end portion to the second end portion and a heat dissipation member at least partially attached to the conductive foil.

According to an embodiment, the thermochromic member may include a base, at least one thermochromic region attached to the base, and an adhesive tape covering the at least one thermochromic region.

According to an embodiment, the cap assembly may include a venting portion for discharging gas generated in the electrode assembly to the outside of the battery cell. At least a portion of the thermochromic member may pass through the venting portion, and the at least one thermochromic region may be exposed to the outside of the cap assembly.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell according to an embodiment.

FIGS. 2A, 2B, and 2C are views illustrating an upper cap assembly according to an embodiment.

FIGS. 3A to 3F are a view illustrating an assembly process of an upper cap assembly and an electrode assembly according to an embodiment.

FIGS. 4A to 4F are a view illustrating an assembly process of an electrode assembly, a jelly roll bag, and a can according to an embodiment.

FIG. 5 illustrates a thermal map of a battery cell according to an embodiment.

FIG. 6 is an exploded perspective view of a battery cell according to an embodiment.

FIGS. 7A and 7B illustrate tape having thermochromic paint according to an embodiment.

FIGS. 8A and 8B illustrate a battery cell including a thermochromic member covering a venting portion according to an embodiment.

FIGS. 9A and 9B illustrate a battery cell including a thermochromic member covering a portion of a venting portion according to an embodiment.

FIGS. 10A and 10B are perspective views of a battery cell including a wrap to which a plurality of thermochromic tapes are attached.

FIG. 11 illustrates a conductive member to which a thermochromic member is attached according to an embodiment.

FIG. 12 is a perspective view of a battery cell including a thermochromic member and a conductive member according to an embodiment.

FIG. 13 illustrates an upper cap assembly having a cap hole according to an embodiment.

FIGS. 14A and 14B are perspective views of a cap plate including a venting hole accommodating a thermochromic tape according to an embodiment.

### DETAILED DESCRIPTION

Embodiments of the present disclosure will be more fully described below with reference to the accompanying drawings, in which like symbols indicate like elements throughout the drawings, and embodiments are shown. However, embodiments of the claims may be implemented in many different forms and are not limited to the embodiments described herein. The examples given herein are non-limiting and only examples among other possible examples.

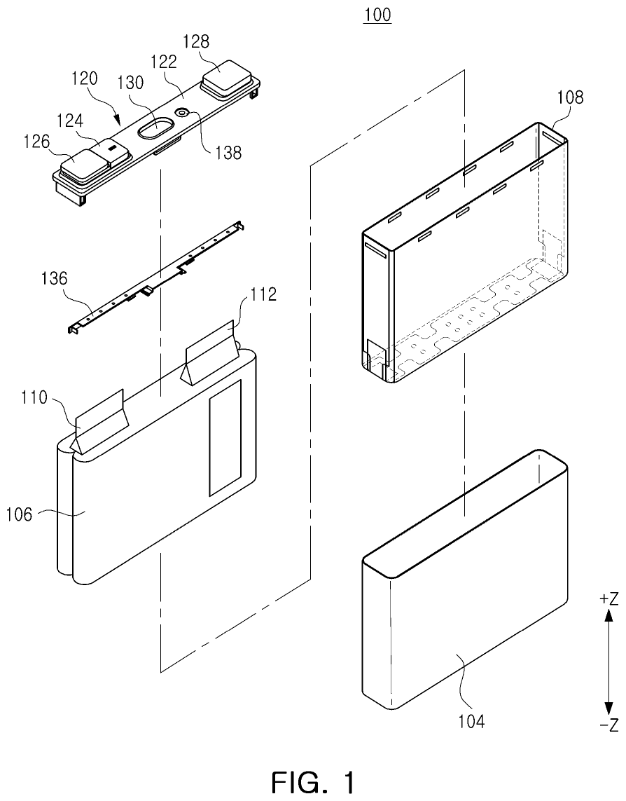

FIG. 1 is an exploded perspective view of a battery cell according to an embodiment.

Referring to FIG. 1, a battery cell 100 may be a prismatic cell. Prismatic cells are widely used in powertrains of electric vehicles. The prismatic cells may be stacked together in a rectangular shape, allowing more efficient use of space. Prismatic cells are generally rectangular and have a higher power density than cylindrical cells. Prismatic cells also provide better performance in cold weather and less damage from vibration. However, prismatic cells may be more expensive to manufacture than cylindrical cells. In addition, prismatic cells are less likely to fail due to vibration or movement. Prismatic cells may deliver more power than cylindrical battery cells due to spatial optimization of the rectangular shape thereof.

The prismatic battery cell 100 includes a rectangular can 104 that may be formed of steel, aluminum, aluminum alloy, plastic, or other metals having sufficient structural strength. The can 104 may be manufactured according to various different methods including deep draw or impact extrusion. The method for manufacturing the can 104 may be combined with wall ironing to achieve the final geometry, thickness, and tolerance. The can 104 may be wrapped with cell cover tape.

A jelly roll 106 includes a stacked anode, cathode, and separator. A jelly roll 106 type electrode assembly configured to have a structure of a long sheet type cathode and a long sheet type anode to which an active material is applied is wound. At the same time, the stacked-type electrode assembly has a structure in which a separator is disposed between a cathode and an anode or has a structure in which a plurality of cathodes and anodes having a predetermined size are sequentially stacked and a separator is disposed between each of the cathodes and the anode. The jelly roll-type electrode assembly is easy to manufacture and has high unit mass and energy density, compared to a sheet-type electrode assembly. In some batteries, one or more jelly rolls 106 are inserted into can 104. Each jelly roll 106 electrode assembly is included inside a polymer jelly roll bag 108 sealed inside the can 104.

Each jelly roll 106 includes a cathode foil 112 formed of aluminum. The aluminum foil is coated with the electrode slurry. A first operation of electrode manufacturing is a slurry mixing process in which an active raw material is combined with a binder, a solvent, and an additive. This mixing process should be performed separately for anode and cathode slurries. Viscosity, density, solids content and other measurable properties of the slurry affect battery quality and electrode uniformity. For example, a slurry having a faster drying rate, a higher solids content, a lower rate capability, and a low viscosity is generated as a solvent content is higher. Thereafter, the cathode slurry is applied to an aluminum foil and dried. A slot die coater is a method of coating a foil in which a slurry is spread through slot gaps on the moving foil receiving tension over rollers. In some embodiments, this may be performed simultaneously on both sides of the foil. This production method enables high speed, while achieving precision in coating thickness. A drying process may be incorporated into a continuous coating. The drying process should achieve three objectives: diffusion of the binder, sedimentation of particles, and evaporation of the solvent. Air floatation is a method of drying the slurry on the foil. Uniformity of the electrode coating and drying process affects the safety, consistency, and life cycle of the prismatic battery cell 100. The electrode should go through a calendaring process in which electrode porosity and twist are controlled by compressing the coated electrode sheet to a uniform thickness and density.

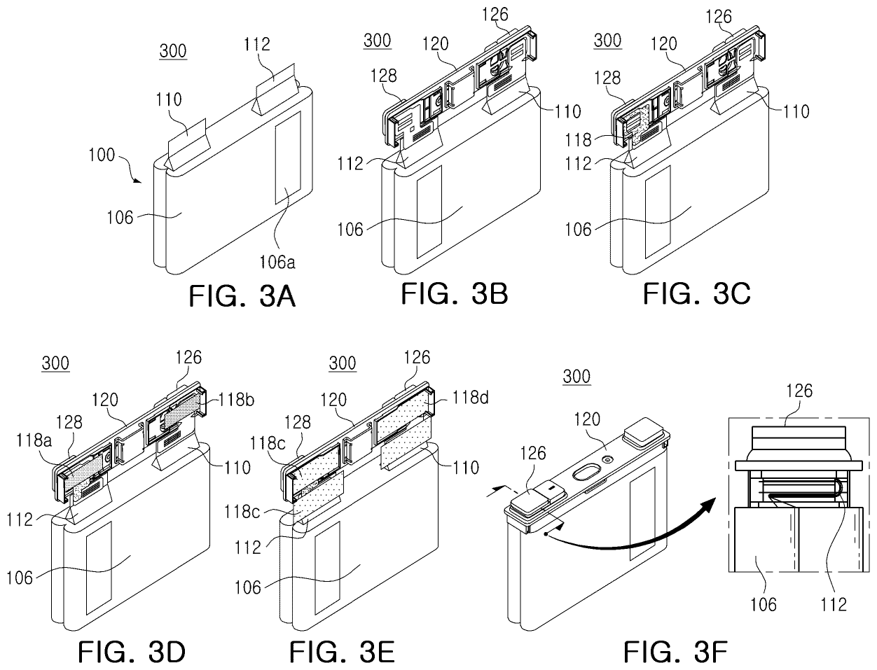

Each jelly roll 106 includes an anode foil 110 formed of copper foil. The anode foil 110 is provided similarly to a cathode foil 112. Each jelly roll 106 may include a cathode connector (not shown) that makes an electrical connection between the inner end portion of the cathode foil 112 and the cathode terminal 128. Each jelly roll 106 may include an anode connector (not shown) that makes an electrical connection between the inner end portion of the anode foil 110 and an anode terminal 126. Each jelly roll 106 may include a cathode connector mask (e.g., a cathode connector mask 118 in FIG. 3C).

Each prismatic battery cell 100 may have an upper cap assembly 120 welded or otherwise bonded to the top of the can 104. The upper cap assembly 120 may include a base plate 122 attached to the can 104. The base plate 122 isolates the inside and outside of the cell by welding with the can 104. The base plate 122 may serve as a rigid support structure for elements within the upper cap assembly 120. The upper cap assembly 120 may include a plurality of upper insulators 124 to insulate the base plate 122. The upper insulator 124 may prevent leakage of an electrolyte from the prismatic battery cell 100. Additionally, the upper insulator 124 may isolate the can 104 from the cathode foil 112 and prevent penetration of moisture and gases from the outside of the cell. A portion of the upper insulator 124 may protect a current interrupting device. The upper cap assembly 120 includes a cathode terminal 128 electrically connecting the inside and outside of the prismatic battery cell 100. The upper cap assembly 120 includes an anode terminal 126 electrically connecting the inside and outside of the prismatic battery cell 100.

The upper cap assembly 120 may include a venting portion 130 allowing exhaust gases from the prismatic battery cell 100 to be discharged in a controlled direction and at a controlled pressure. The upper cap assembly 120 may include a vent guard 132 protecting the venting portion 130 from the inside of the prismatic battery cell 100 in order to prevent the venting portion 130 from malfunctioning. The upper cap assembly 120 may include an overcharge safety device 134 preventing an external current from being introduced using an internal gas pressure of the prismatic battery cell 100. The upper insulator 124 may be multi-component. In some embodiments, side portions of the upper insulator 124 may be mounted on the edges of the can 104 and the upper cap assembly 120. An electrolyte cap 138 may seal an electrolyte solution inside the prismatic battery cell 100. The upper cap assembly 120 may be referred to as a cap plate or a cap assembly.

The battery cell 100 may include an insulator 136 located between the upper cap assembly 120 and the can 104.

In this document, the electrode assembly of the battery cell 100 is described as the jelly roll 106, but the electrode assembly of the battery cell 100 is not limited to the jelly roll 106. For example, the jelly roll 106 may be replaced with a stack type electrode assembly or a Z-folding type electrode assembly. According to an embodiment, the jelly roll 106 described herein may refer to an electrode assembly.

In this document, the can 104 may be referred to as a case.

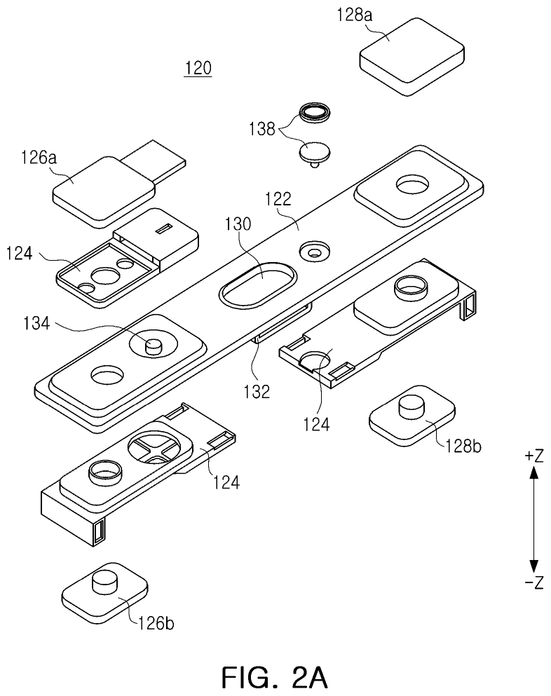

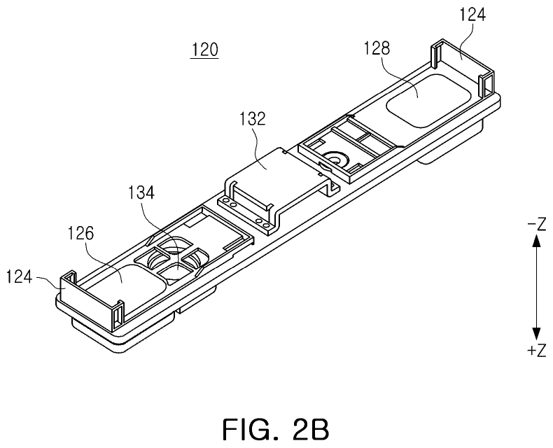

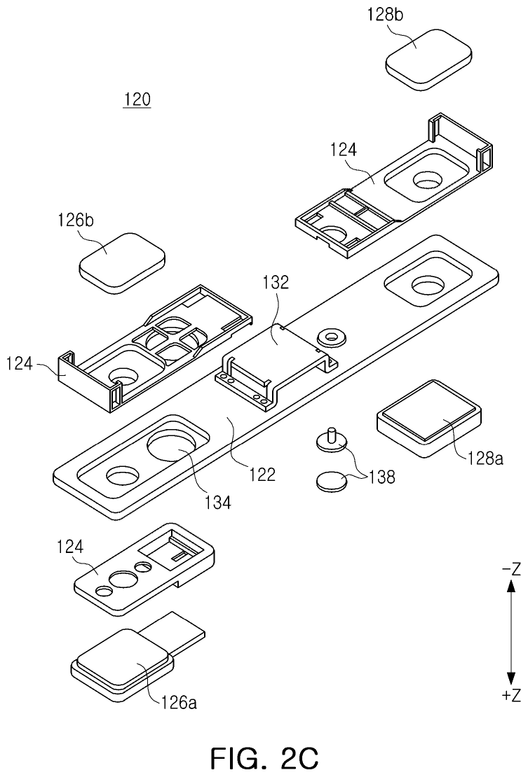

FIGS. 2A, 2B and 2C are views illustrating an upper cap assembly 120. For example, FIG. 2A is an exploded perspective view of the upper cap assembly 120 according to an embodiment of the present disclosure. FIG. 2B is a rear perspective view of the upper cap assembly 120 according to an embodiment of the present disclosure. Description of the upper cap assembly 120 of FIG. 1 may be applied to the upper cap assembly 120 of FIGS. 2A, 2B and 2C.

The upper cap assembly 120 serving as a cover for the prismatic battery cell 100 is a complex assembly including a plurality of welded components. Adhesives may be used instead of welding specific components.

The prismatic battery cell 100 may include the venting portion 130. The venting portion 130 provides overpressure alleviation when temperature and corresponding pressure increase in the prismatic battery cell 100. For example, the venting portion 130 may be activated in a pressure range of 10 to 15 bar. The venting portion 130 may be laser-welded to the upper cap assembly 120.

The prismatic battery cell 100 may include the can 104. The can 104 may generally be formed of deep-drawn aluminum or stainless steel to prevent moisture from entering the cell, while providing diffusion resistance to organic solvents, such as liquid electrolytes. The most important reason the can 104 is typically formed of deep-drawn aluminum alloy or stainless steel is to reduce a welding point to improve the mechanical strength of the can 104. The prismatic battery cell 100 may be filled with an electrolyte. After electrolyte filling, the electrolyte cap 138 may be welded to the upper cap assembly 120 or a locking ball (not shown) may be forced into an opening of the electrolyte cap 138. The cell may have an overcharge safety device 134 that may disconnect current flow when high internal pressure is reached in the prismatic battery cell 100. A rise in pressure is usually a result of high temperatures.

According to an embodiment, the cathode terminal 128 may be provided in plural. For example, the cathode terminal 128 may include a first cathode terminal 128a in which at least a portion is exposed to the outside of the battery cell 100 and a second cathode terminal 128b connected to a cathode foil (e.g., the cathode foil 112 of FIG. 1). The second cathode terminal 128b may be electrically connected to the first cathode terminal 128a. For example, a portion of the second cathode terminal 128b may contact the first cathode terminal 128a.

According to an embodiment, the anode terminal 126 may be provided in plural. For example, the anode terminal 126 may include a first anode terminal 126a in which at least a portion is exposed to the outside of the battery cell 100 and a second anode terminal 126b connected to an anode foil (e.g., the anode foil 110 of FIG. 1). The second anode terminal 126b may be electrically connected to the first anode terminal 126a. For example, a portion of the second anode terminal 126b may contact the first anode terminal 126a.

FIGS. 3A to 3F are a view illustrating an assembly process of an upper cap assembly and an electrode assembly according to an embodiment. A battery cell manufacturing process 300 may include an assembly process of the upper cap assembly 120 and the jelly roll 106.

Referring to FIG. 3A, a sealing tape 106a may be attached to the jelly roll 106. According to an embodiment, the sealing tape 106a may cover at least a portion of the jelly roll 106. According to an embodiment, the sealing tape 106a may seal a portion of the jelly roll 106.

Referring to FIG. 3B, the jelly roll 106 may be connected to the upper cap assembly 120. For example, a connection component for connecting the jelly roll 106 and the upper cap assembly 120 may be prepared. The upper cap assembly 120 may be closely attached to the jelly roll 106 using the connection component. For example, the cathode terminal 128 of the upper cap assembly 120 may be connected to the cathode foil 112 of the jelly roll 106, and the anode terminal 126 of the upper cap assembly 120 may be connected to the jelly roll 106. The cathode terminal 128 may be welded to the cathode foil 112 and the anode terminal 126 may be welded (e.g., ultrasonic-welded) to the anode foil 110.

Referring to FIG. 3C, at least a portion of the cathode terminal 128 may be masked. For example, the cathode connector mask 118 may be disposed to cover a portion of the cathode terminal 128. The cathode connector mask 118 may protect the cathode terminal 128. Although not shown, the description of the masking of the cathode terminal 128 may be applied to the anode terminal 126 as well.

Referring to FIG. 3D and/or FIG. 3E, tape may be attached to at least a portion of the cathode terminal 128 and the anode terminal 126. For example, the battery cell 100 may include welding tapes 118a, 118b, 118c, and 118d attached to at least a portion of the cathode terminal 128, the anode terminal 126, the cathode foil 112, and/or the anode foil 110. According to an embodiment, the welding tapes 118a, 118b, 118c, 118d may be attached to at least a portion of a joint portion of the cathode terminal 128, the anode terminal 126, the cathode foil 112, and/or the anode foil 110. As the joint portion is covered with the welding tapes 118a, 118b, 118c, and 118d, the cathode terminal 128 and the anode terminal 126 may be protected.

Referring to FIG. 3F, the anode foil 110 connected to the anode terminal 126 may be folded. For example, when the upper cap assembly 120 is disposed on the jelly roll 106, at least a portion of the anode foil 110 may be folded. Although not shown, when the upper cap assembly 120 is placed on the jelly roll 106, the cathode foil 112 may also be folded.

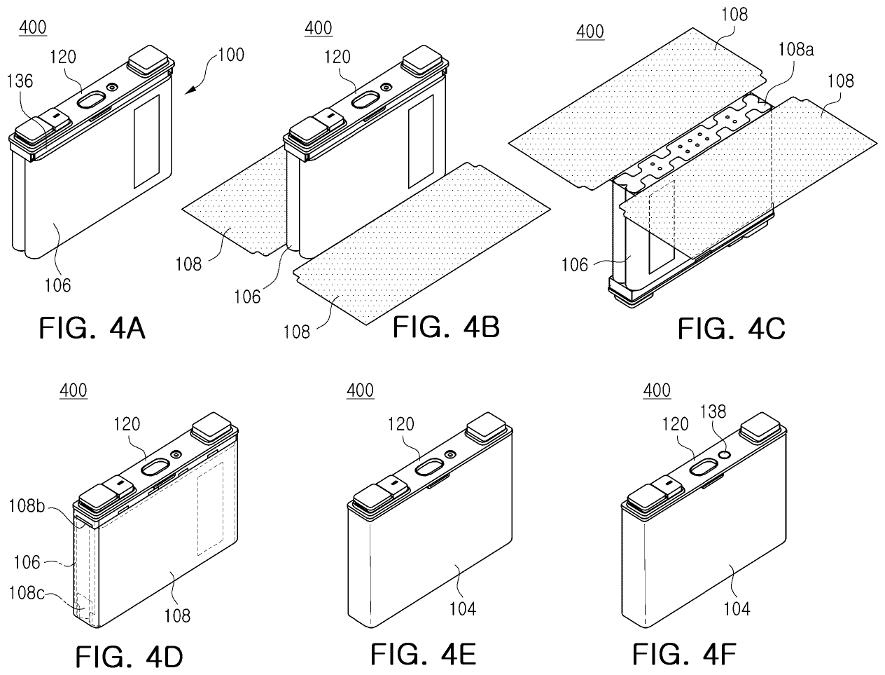

FIGS. 4A to 4F are a view illustrating an assembly process of an electrode assembly, a jelly roll bag, and a can. A battery cell manufacturing process 400 may include an assembly process of the jelly roll 106, the jelly roll bag 108, and the can 104.

Referring to FIG. 4A, an insulator 136 may be installed on the battery cell 100. For example, the insulator 136 may be disposed between the can 104 and the cap assembly 120.

Referring to FIG. 4B, the jelly roll bag 108 may be prepared. The jelly roll bag 108 may cover at least a portion (e.g., a side surface) of the jelly roll 106. The jelly roll 106 may be surrounded by the jelly roll bag 108. The jelly roll bag 108 may protect the jelly roll 106 from external impact. In FIG. 4B, a structure in which the jelly roll bag 108 is disposed on two side surfaces of the jelly roll 106 is shown, but the structure of the jelly roll bag 108 is not limited thereto. For example, according to an embodiment, the jelly roll bag 108 may be formed to cover four side surfaces of the jelly roll 106.

Referring to FIG. 4C, an insulator 108a may be attached to the jelly roll 106. According to an embodiment, in a state in which the jelly roll bag 108 is unfolded, the insulator 108a may be attached to a lower portion of the jelly roll 106. The insulator 108a may be referred to as a lower insulator.

Referring to FIG. 4D, at least some of the components of the battery cell 100 may be taped. For example, the battery cell 100 may include the upper cap assembly 120, the can 104, and/or at least one first tape 108b attached onto insulator 136, and/or a second tape 108c attached to a lower portion of the jelly roll bag 108 along a side portion of the insulator 136.

Referring to FIG. 4E, the jelly roll 106 may be inserted into the can 104. The jelly roll 106 and/or the jelly roll bag 108 may be inserted into the can 104.

According to an embodiment, the battery cell manufacturing process 400 may include a wetting process of the jelly roll 106. For example, the jelly roll 106 may be initially wetted by an electrolyte delivered through an electrolyte injection port. For example, partial vacuum may be formed in the prismatic battery cell 100, and a predetermined amount of electrolyte may be injected through the electrolyte injection port. The partial vacuum may improve the distribution and wetting of all layers within the jelly roll 106. Wetting of all layers within the jelly roll 106 may require a rolling or spinning protocol to enhance wetting.

According to an embodiment, the battery cell manufacturing process 400 may include a quality check process for the initial wetting process, such as checking a weight of the prismatic battery cell 100 immediately after charging. For example, a second electrolyte charging operation in which an electrolyte is charged to achieve a desired weight may be applied to the battery cell. According to an embodiment, the battery cell manufacturing process 400 may include a pre-formation process of charging the prismatic battery cell 100 and discharging gas.

Referring to FIG. 4F, the electrolyte injection port may be sealed. For example, the electrolyte cap 138 may be inserted into the electrolyte injection port.

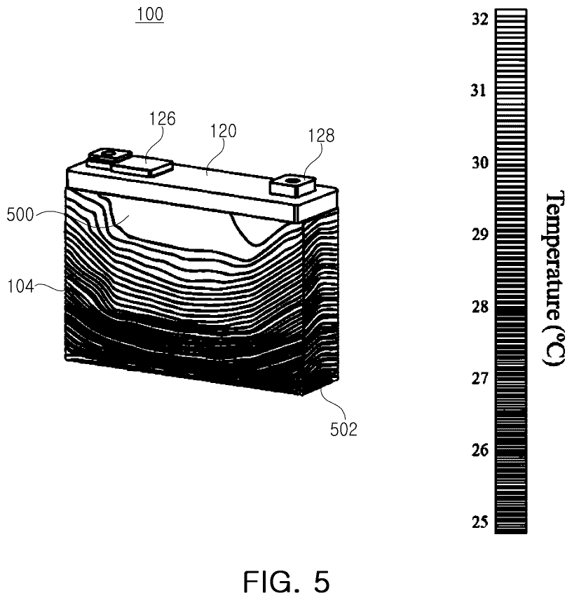

FIG. 5 illustrates a thermal map of a prismatic battery cell 100.

Referring to FIG. 5, a battery cell 100 may include a can 104 and an upper cap assembly 120. Descriptions of the can 104 and the upper cap assembly 120 of FIGS. 1, 2A, 2B and/or 2C may be applied to the can 104 and the upper cap assembly 120 of FIG. 5.

A temperature of the battery cell 100 may be different for each position. For example, the temperature of the battery cell 100 may be represented by a color band indicated by a line. In FIG. 5, the temperature of the battery cell 100 is lower as the color band density increases.

According to an embodiment, several color bands are shown across the surface of the can 104 during charging and discharging of the prismatic battery cell 100. A temperature of the battery cell 100 may be higher as it is closer to a in which current flow is concentrated. For example, a temperature of a first region 500 of the battery cell 100 may be higher than a temperature of a second region 502. The first region 500 may be a portion of the can 104 closer to the upper cap assembly 120 than the second region 502. Such data is obtained from “Test Method for Thermal Characterization of Li-Ion Cells and Verification of Cooling Concepts” by Christen et al.

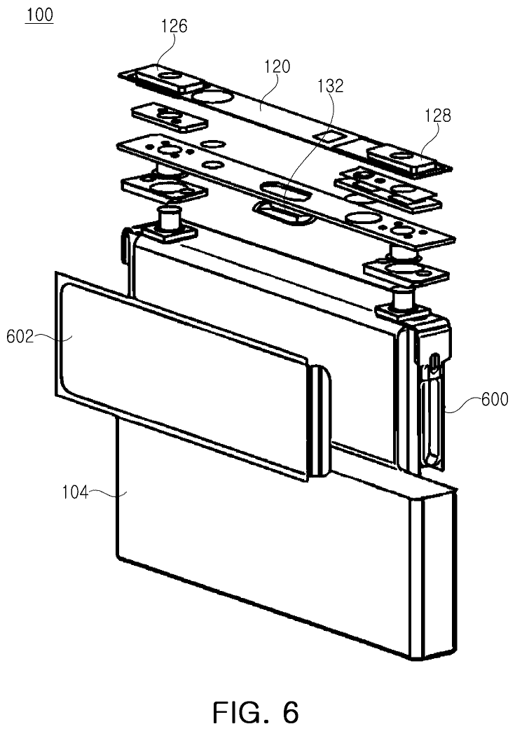

FIG. 6 is an exploded perspective view of a battery cell.

Referring to FIG. 6, the battery cell 100 may include the can 104, a jelly roll 106, and the upper cap assembly 120. The description of the battery cell 100 including the can 104, jelly roll 106, and upper cap assembly 120 described above (e.g., FIGS. 1 to 5) may be applied to the battery cell 100 including the can 104, the jelly roll 106, and the upper cap assembly 120 of FIG. 6.

In this document, upper cap assembly 120 and can 104 may be referred to as a housing of the battery cell 100.

The upper cap assembly 120 may include a cathode terminal 128, an anode terminal 126, and a vent guard 132.

According to an embodiment, the jelly roll 106 may include a cathode connector 116 and/or an anode connector 114. The cathode connector 116 and anode connector 114 connect the jelly roll 106 to the upper cap assembly 120. For example, the cathode connector 116 is electrically connected to a cathode of the jelly roll 106 and to the cathode terminal 128. The anode connector 114 is electrically connected to an anode of jelly roll 106 and to the anode terminal 126.

According to an embodiment, the battery cell 100 may include a side connector 600. The side connector 600 may electrically connect the jelly roll 106 to the cathode terminal 128 and/or the anode terminal 126. For example, the side connector 600 may replace the cathode connector 116 and the anode connector 114. The side connector 600 may be connected to an electrode (e.g., a cathode electrode and/or an anode electrode). In an embodiment not shown, the side connector 600 may be omitted.

According to an embodiment, the battery cell 100 may include an adhesive tape 602. The adhesive tape 602 may fix the jelly roll 106 to the can 104. The adhesive tape 602 may cover at least a portion of the jelly roll 106. In an embodiment, the adhesive tape 602 may be provided as tape, a portion of tape, or foil.

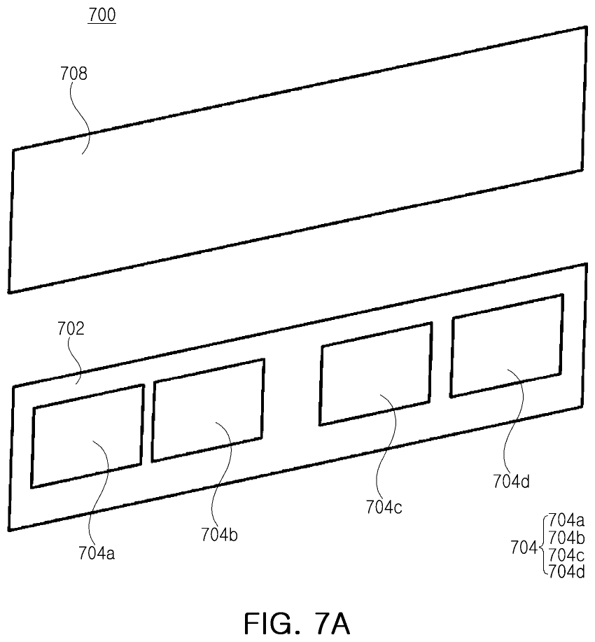

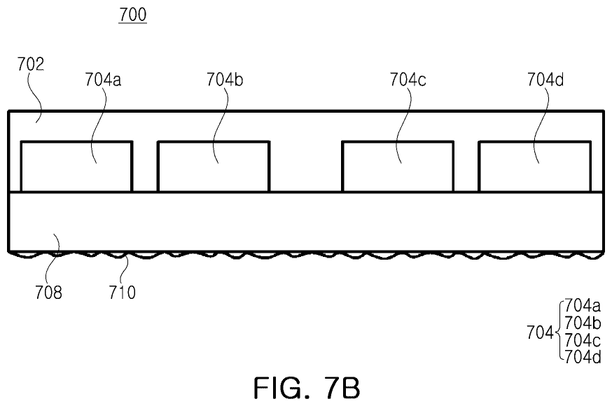

FIG. 7A is an exploded view of a thermochromic member having a thermochromic paint according to an embodiment. FIG. 7B is a schematic view illustrating an inside of a thermochromic member.

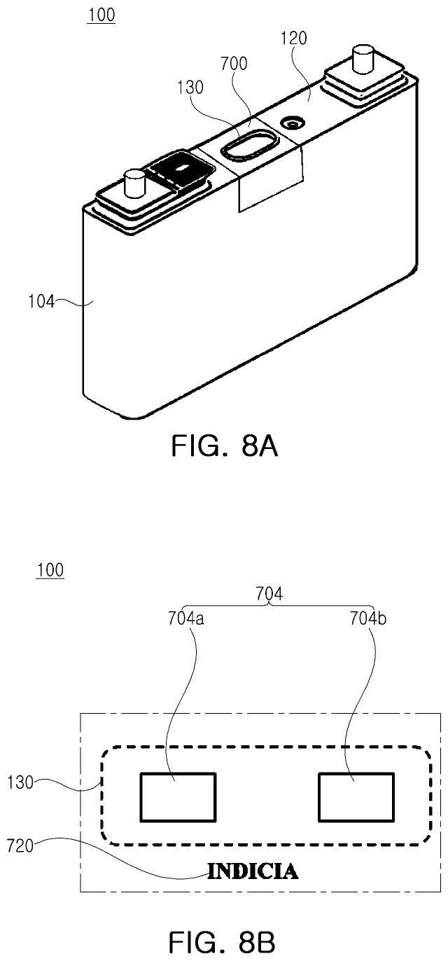

According to an embodiment, a thermochromic member 700 may include a base 702, at least one thermochromic region 704, and an adhesive tape 708. The adhesive tape 708 may be used to attach the base 702 and the thermochromic region 704 to a battery cell (e.g., the battery cell 100 of FIG. 1). For convenience of description, only a portion of the adhesive tape 708 is shown in FIG. 8B. In an embodiment, the thermochromic member 700 may be referred to as a thermochromic tape.

The base 702 may accommodate at least one thermochromic region 704. The thermochromic region 704 may include a thermochromic dye. A thermochromic region 704 may be applied to or coated on the base 702. In an embodiment, the base 702 may be referred to as a lower tape or base tape.

According to an embodiment, the thermochromic region 704 may include a thermochromic dye configured to change color at an activation temperature. According to an embodiment, the thermochromic region 704 may include a plurality of thermochromic regions 704a, 704b, 704c, and 704d having different activation temperatures. An activation temperature of the thermochromic region 704 may be selectively designed depending on a component on which the thermochromic member 700 is disposed.

FIGS. 7A and 7B illustrate a structure with four thermochromic regions 704, but the number of thermochromic regions 704 is not limited thereto. For example, the number and/or size of the thermochromic regions 704 may be selectively designed depending on the design of the battery cell 100.

In an embodiment, a first thermochromic region 704a may have an activation temperature of 25° C. and a second thermochromic region 704 may have an activation temperature of 60° C.

According to an embodiment, the adhesive tape 708 may be attached to the base 702 and the thermochromic region 704. As the adhesive tape 708 covers the base 702 and the thermochromic region 704, the thermochromic dye may be protected from environmental damage that may interfere with the ability thereof to provide a thermochromic reaction at a specified temperature. For example, the thermochromic dye included in the thermochromic member 700 may be sealed by the adhesive tape 708 and the base 702 to be protected.

According to an embodiment, the thermochromic member 700 may include an adhesive 710 attaching the adhesive tape 708 to the base 702 and/or other parts (e.g., the can 104) of the battery cell 100. In an embodiment, the adhesive tape 708 may be a transparent tape.

Based on a change in temperature of the thermochromic member 700, a user and/or an operator may detect or monitor a temperature of the battery cell 100. For example, a temperature of the battery cell 100 may be detected during charging or discharging of the battery cell 100. Based on the detected temperature of the battery cell 100, the charging or discharging operation may be stopped to prevent gas discharge from the jelly roll 106 or to determine the stability of the battery cell 100. Since the temperature of the battery cell 100 may be detected without a separate measuring device, costs consumed in a test process of the battery cell 100 may be reduced.

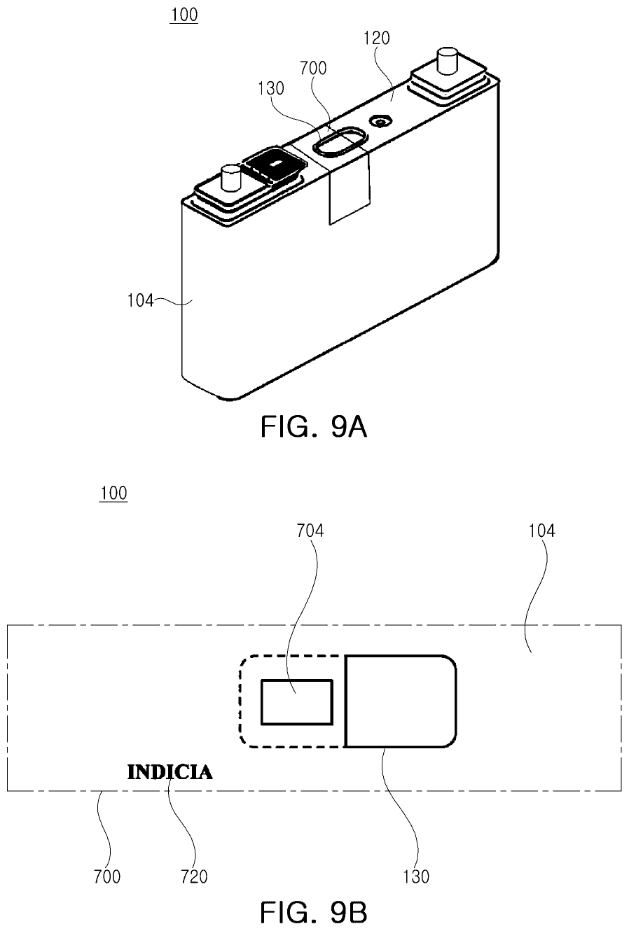

FIGS. 8A and 8B illustrate a battery cell including a thermochromic member covering a venting portion according to an embodiment. For example, FIG. 8A is a perspective view of the battery cell 100 including the thermochromic member 700 covering a venting portion 130. FIG. 8B is a top view of the battery cell 100 including the thermochromic member 700 covering the venting portion 130. FIGS. 9A and 9B illustrate a battery cell including a thermochromic member covering a portion of a venting portion according to an embodiment. For example, FIG. 9A is a perspective view of the battery cell 100 including the thermochromic member 700 covering a portion of the venting portion 130. FIG. 9B is a top view of the battery cell 100 including the thermochromic member 700 covering a portion of the venting portion 130.

Referring to FIGS. 8A, 8B, 8C, and/or 8D, the battery cell 100 may include the can 104, the upper cap assembly 120, the venting portion 130, and/or the thermochromic member 700. The description of the battery cell 100, the can 104, the upper cap assembly 120, the venting portion 130, and/or the thermochromic member 700 of FIGS. 1, 2A to 2C, 7A and/or 7B may be applied to the battery cell 100, the can 104, the upper cap assembly 120, the venting portion 130, and/or the thermochromic member 700 of FIGS. 8A, 8B, 8C, and/or 8D.

According to an embodiment (e.g., FIGS. 8A and 8B), the thermochromic member 700 may be attached to the battery cell 100 on the venting portion 130. Due to the thermochromic member 700 attached to the venting portion 130, a temperature of a venting gas may be identified through visual observation. The thermochromic member 700 may cover a portion (e.g., a portion of the side) of the can 104 and a portion of the upper cap assembly 120.

According to an embodiment, the thermochromic member 700 may include at least one thermochromic region 704. According to an embodiment (e.g., FIG. 8B), the thermochromic member 700 may have multiple regions with thermochromic regions 704 having different activation temperature thresholds. For example, the thermochromic region 704 of the thermochromic member 700 may include a first thermochromic region 704a having a first activation temperature and a second thermochromic region 704b having a second activation temperature, different from the first activation temperature, and spaced apart from the first thermochromic region 704a. In an embodiment, the first activation temperature of the first thermochromic region 704a may be 25° C., and the second activation temperature of the second thermochromic region 704b may be 30° C.

According to an embodiment, the thermochromic member 700 may have an indicia region 720 capable of illustrating a color representing a problem of the battery cell 100 to a user. In an embodiment, the display region 720 may be a portion of the thermochromic member 700 coated with a thermochromic dye in a designated shape or a letter shape. In an embodiment, a color of the display region 720 may be changed based on the temperature of the battery cell 100, and the user or operator may be warned of the temperature of the battery cell 100.

According to an embodiment (e.g., FIGS. 9A and 9B), the venting portion 130 may be partially covered by the thermochromic member 700. For example, the dotted line in FIG. 9B indicates a portion of the venting portion 130 covered by the thermochromic member 7000, and the solid line portion of the venting portion 130 indicates a portion of the venting portion 130 through which venting gas may be discharged without resistance.

For example, the thermochromic member 700 may be attached to the can 104 and/or the upper cap assembly 120, while covering a portion of the venting portion 130. The thermochromic member 700 may limit the venting gas discharged from the venting portion 130.

For example, the thermochromic member 700 may control the resistance amount of the venting portion 130 and express the temperature of gas discharged from the venting portion 130 through color.

According to an embodiment, the thermochromic member 700 may be damaged or melted at a designated temperature, thereby allowing the battery cell 100 to discharge gas when necessary.

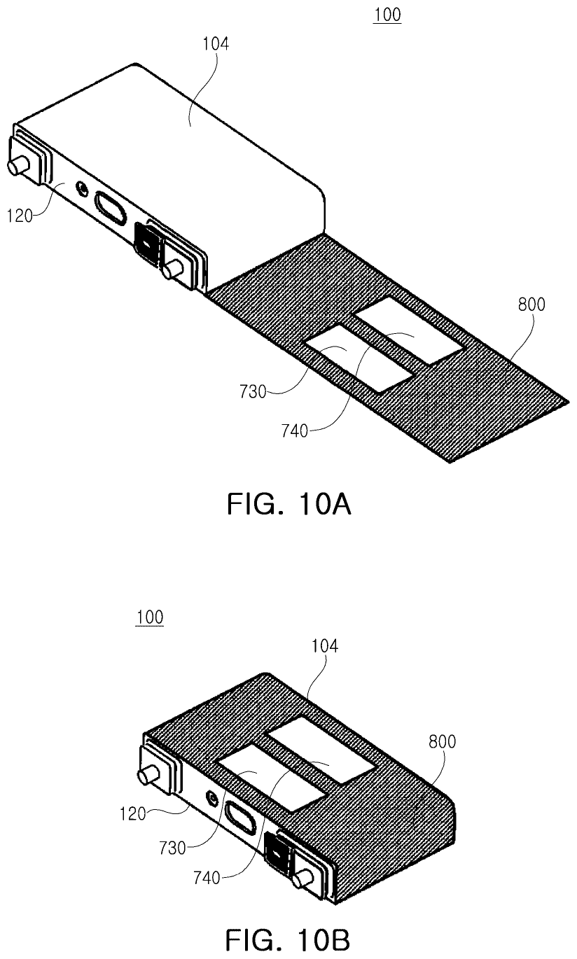

FIGS. 10A and 10B are perspective views of a battery cell including a wrap to which the thermochromic member 700 is attached.

Referring to FIGS. 10A and/or 10B, battery cell 100 may include the can 104, the upper cap assembly 120, and/or a wrap 800. Description of the battery cell 100, the can 104, and/or the upper cap assembly 120 of FIGS. 1, 2A to 2C, 7A and/or 7B may be applied to the battery cell 100, the can 104, and/or upper the cap assembly of FIGS. 10A and/or 10B.

According to an embodiment, the wrap 800 is designed to protect the battery cell 100 from environmental and physical damage, while providing functional and structural support to the battery cell 100.

According to an embodiment, the wrap 800 may surround at least a portion of the can 104. According to an embodiment, the wrap 800 may be at least a portion of the thermochromic member 700 of FIGS. 7A and/or 7B. For example, the thermochromic member 700 may cover at least a portion of a side surface of the can 104 (e.g., a case). For example, the wrap 800 may be adhesive tape 708 and/or base 702. According to another embodiment, the wrap 800 may be a flexible resin connected to the thermochromic member 700 of FIGS. 7A and/or 7B.

Referring to FIG. 10A, the thermochromic member 700 attached to the wrap 800, before being attached to the battery cell 100, is illustrated.

Referring to FIG. 10B, the wrap 800 may cover at least a portion of the side surface of the can 104.

According to an embodiment, the battery cell 100 may include at least one thermochromic region 730 and 740 attached to the wrap 800. For example, the thermochromic member (e.g., the thermochromic member 700 or the wrap 800 of FIG. 7) may include a first thermochromic region 730 and a second thermochromic region 740 spaced apart from the first thermochromic region 730. A first activation temperature of the first thermochromic region 730 may be different from a second activation temperature of the second thermochromic region 740.

Such an embodiment may allow for visual indications outside the battery cell 100 to show the temperatures of different regions of the battery cell 100. Thermochromic paints of different activation temperatures may be used in different regions of the battery cell 100.

For example, the first thermochromic region 730 may have a first activation temperature of 32° C., and the second thermochromic region 740 may have a second activation temperature of 27° C.

The first thermochromic region 730 may be disposed to be closer to the upper cap assembly 120 than the second thermochromic region 740. The first activation temperature of the first thermochromic region 730 may be higher than the second activation temperature of the second thermochromic region 740.

The temperature of the battery cell 100 may be higher as it is closer to the upper cap assembly 120 due to the density of current flow. Since the first activation temperature is higher than the second activation temperature, the temperature of the battery cell 100 may be accurately displayed.

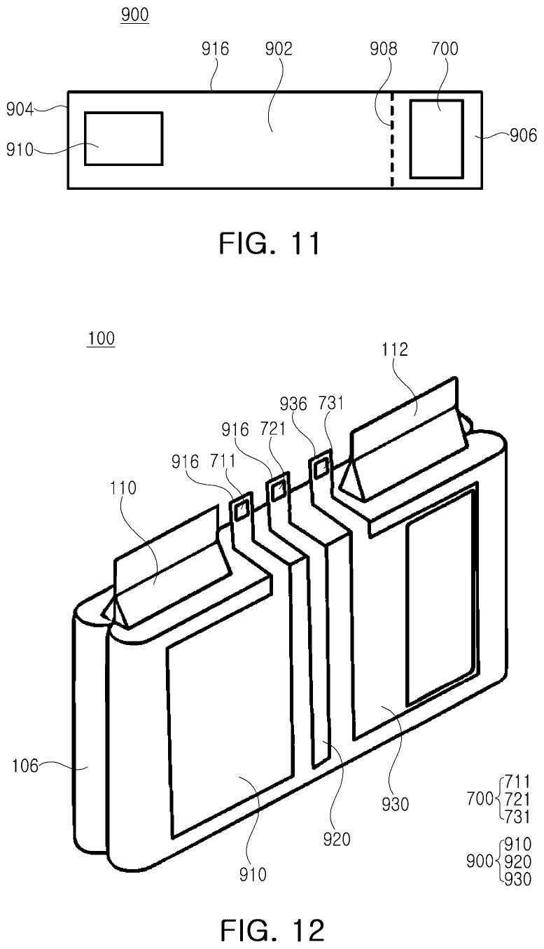

FIG. 11 illustrates a conductive member to which a thermochromic member is attached according to an embodiment.

Description of the thermochromic member 700 of FIGS. 7A and/or 7B may be applied to the thermochromic member 700 of FIG. 11.

Referring to FIG. 11, a conductive member 900 equipped with a thermochromic member 700 may be provided. In an embodiment, the conductive member 900 may be referred to as a conductive tape or conductive foil plus tape. The thermochromic member 700 may be thermally connected to the can 104 or the upper cap assembly 120 using the conductive member 900.

The thermochromic member 700 may express the temperature of the battery cell 100 in a position spaced apart from the battery cell 100 by using the conductive member 900. The user and/or operator may monitor the temperature of the battery cell 100 using the thermochromic member 700 during charging or discharging of the battery cell 100.

The conductive member 900 may include a conductive foil 902, a first end portion 904 located at one end of the conductive foil 902 and a second end portion 906 located at the other end of the conductive foil 902. The first end portion 904 may be referred to as a proximal end portion and second end portion 906 may be referred to as a distal end portion.

In an embodiment, it may be desirable to have a visual indication of the temperature of one or more portions of battery cell 100 that are not directly visible to the user or the sensor. In such a case, the conductive foil 902 formed of copper, aluminum or other conductive metal may be installed in the battery cell 100. At least a portion of the heat transferred from the first end portion 904 may pass through the conductive foil 902 and be transferred to the second end portion 906.

The first end portion 904 may be attached to a portion of the battery cell 100 for which temperature monitoring is required, and the second end portion 906 may extend to the outside of the can 104. In an embodiment, the second end portion 906 may be exposed to the outside of the battery cell 100.

The dotted line 908 in FIG. 11 indicates a division line between a portion (e.g., the second end portion 906) of the conductive member 900 visible from the outside of the battery cell 100 and a portion of the conductive member 900 located inside the can 104.

According to an embodiment, the thermochromic member 700 may be attached to the conductive member 900. For example, a thermochromic region (e.g., the thermochromic region 704 in FIG. 7A) of the thermochromic member 700 may be attached on the second end portion 906.

During charging or discharging of the battery cell 100, the conductive member 900 may conduct heat to the thermochromic member 700 to visually indicate the temperature of an invisible portion of the battery cell 100.

According to an embodiment, the conductive member 900 may include a heat dissipation member 910 to improve thermal conductivity transferred from the first end portion 904 to the second end portion 906. In an embodiment, the heat dissipation member 910 may be attached on the first end portion 904 and/or the conductive foil 902. In an embodiment, the heat dissipation member 910 may be referred to as a window.

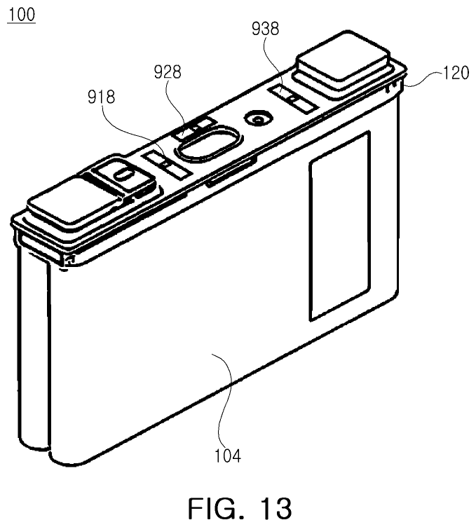

FIG. 12 is a perspective view of a battery cell including a thermochromic member and a conductive member according to an embodiment. FIG. 13 is a perspective view of a battery cell including an upper cap assembly including at least one through-hole according to an embodiment.

Referring to FIGS. 12 and/or 13, the battery cell 100 may include a jelly roll 106, a cathode foil 112, an anode foil 110, an upper cap assembly 120, a thermochromic member 700, and a conductive member 900. Description of the battery cell 100, the cathode foil 112, the anode foil 110, and the upper cap assembly 120 of FIG. 1, the thermochromic member 700 of FIG. 7A and/or 7B, and the conductive member 900 of FIG. 11 may be applied to the battery cell 100, the thermochromic member 700, and/or the conductive member 900 of FIGS. 12 and/or 13.

According to an embodiment, the battery cell 100 may include at least one conductive member 900.

For example, the conductive member 900 may include a first conductive member 910, a second conductive member 920, and a third conductive member 930 spaced apart from each other. Each conductive member 900 may include a first end portion (e.g., the first end portion 904 of FIG. 11) attached to a portion (e.g., the jelly roll 106) of the battery cell 100 and a second end portion (e.g., the second end portion 906 of FIG. 11) opposite to the first end portion 904. The second end portions 906 of the first conductive member 910, the second conductive member 920, and the third conductive member 930 may be referred to as a first exposed region 916, a second exposed region 926, and a third exposure region 936, respectively.

The thermochromic member 700 may be attached on the second end portion 906 of the conductive member 900. For example, the thermochromic member 700 may include a first thermochromic region 711 attached to the first exposed region 916, a second thermochromic region 721 attached to the second exposed region 926, and a third thermochromic region 731 attached to the third exposed region 936. The description of the thermochromic region 704 of FIGS. 7A and 7B may be applied to the first thermochromic region 711, the second thermochromic region 721, and/or the third thermochromic region 731.

According to an embodiment, the first conductive member 910, the second conductive member 920, and the third conductive member 930 may each include a first end portion (e.g., the first end portion 904 of FIG. 11) attached to another component of the battery cell. Each of the conductive members 900 may be used to monitor the temperature of different regions. For example, monitoring may be performed on various positions (e.g., the anode region, the jelly roll region, and the cathode region) of the battery cell 100 using the plurality of thermochromic members 700 respectively connected to the plurality of conductive members 900.

According to an embodiment, the upper cap assembly 120 may include at least one through-holes 918, 928, and 938. According to an embodiment, at least a portion of the conductive member 900 may be exposed through the through-hole 129 of the upper cap assembly 120. For example, the upper cap assembly 120 may include a first through-hole 918, a second through-hole 928, and a third through-hole 938 spaced apart from each other. For example, the first conductive member 910 may include a first exposed region 916 exposed to the outside of the battery cell 100 through the first through-hole 918. The second conductive member 920 may include a second exposed region 926 exposed to the outside of the battery cell 100 through the second through-hole 928. The third conductive member 930 may include a third exposed region 936 exposed to the outside of the battery cell 100 through the third through-hole 938. According to an embodiment, the through-holes 918, 928, and 938 may be disposed to be adjacent to the venting portion 130.

Although three conductive members 900 and three through-holes 918, 928, and 938 are shown in FIGS. 12 and/or 13, the number of conductive members 900 and through-holes 918, 928, and 938 may be selectively designed.

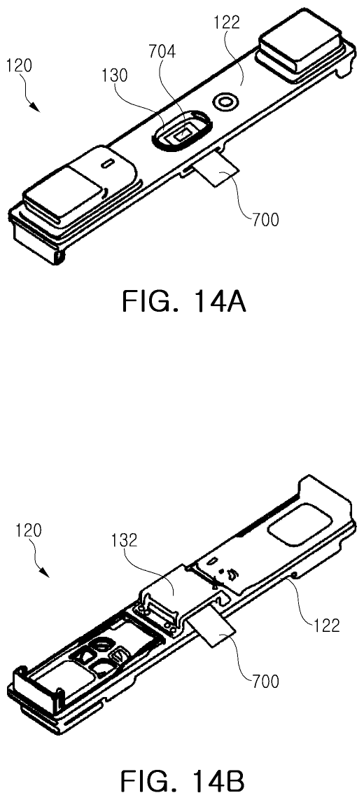

FIGS. 14A and 14B are perspective views of an upper cap assembly including a venting portion accommodating a thermochromic member, according to an embodiment. For example, FIG. 14A is a front perspective view of the upper cap assembly 120 including the venting portion 130 accommodating the thermochromic member 700, and FIG. 14B is a rear perspective view of the upper cap assembly 120 including the venting portion 130 accommodating the thermochromic member 700

The description of the upper cap assembly 120, the base plate 122, the venting portion 130, the vent guard 132, and the thermochromic member 700 of FIGS. 2A to 2C and 7A may be applied to the upper cap assembly 120, the base plate 122, the venting portion 130, the vent guard 132, and the thermochromic member 700 of FIGS. 14A and 14B.

Referring to FIGS. 14A and 14B, at least a portion of the thermochromic member 700 may pass through the venting portion 130 of the upper cap assembly 120 to be visually exposed. For example, at least a portion of the thermochromic member 700 may be accommodated in an empty space defined by the venting portion 130. The thermochromic member 700 may include a thermochromic region 704 visually exposed to the outside of the upper cap assembly 120. The thermochromic member 700 may allow gas to be discharged from the jelly roll (e.g., the jelly roll 106 of FIG. 1), while measuring the temperature of the gas discharged from the venting portion 130.

The functions performed in the processes and methods may be implemented in a different order. In addition, the schematic operations and actions are provided as examples only, and some of the operations and actions may be optional, combined into fewer operations and actions, or extended with additional operations and actions, without detracting from the essence of the disclosed embodiments.

According to an embodiment of the present document, a temperature of the battery cell may be visually displayed using the thermochromic member including a thermochromic dye. Since the temperature of the battery cell is visually displayed, a separate temperature measuring device may not be required.

According to an embodiment of the present document, since an overheated battery cell is detected or monitored using the thermochromic member, operator convenience for replacing a battery cell in which an event occurs may be improved. In addition, test costs may be reduced and quality of the battery device may be improved.

Only specific examples of implementations of certain embodiments are described. Variations, improvements and enhancements of the disclosed embodiments and other embodiments may be made based on the disclosure of this patent document.

What is claimed is:

1. A battery cell comprising:
an electrode assembly;
a housing including a case accommodating the electrode assembly and a cap assembly covering the case; and
a thermochromic member thermally connected to the housing,
wherein the thermochromic member includes a thermochromic region configured to change color based on temperature.

2. The battery cell of claim 1, wherein
the cap assembly includes a venting portion for discharging gas generated in the electrode assembly to the outside of the battery cell, and
the thermochromic member covers at least a portion of the venting portion.

3. The battery cell of claim 2, wherein the thermochromic member includes a display region coated with a thermochromic dye in a designated shape or letter shape.

4. The battery cell of claim 1, wherein the thermochromic member covers at least a portion of a side surface of the case.

5. The battery cell of claim 1, wherein the thermochromic member includes a first thermochromic region and a second thermochromic region spaced apart from the first thermochromic region.

6. The battery cell of claim 5, wherein
the first thermochromic region is configured to change color at a first activation temperature, and
the second thermochromic region is configured to change color at a second activation temperature, lower than the first activation temperature.

7. The battery cell of claim 6, wherein the first thermochromic region is closer to the cap assembly than the second thermochromic region.

8. The battery cell of claim 1, further comprising:
a conductive member including a first end portion attached to the housing and a second end portion exposed to the outside of the battery cell,
wherein the thermochromic member is attached on the second end portion of the conductive member.

9. The battery cell of claim 8, wherein
the cap assembly includes a through-hole, and
at least a portion of the conductive member passes through the through-hole to be exposed to the outside of the battery cell.

10. The battery cell of claim 9, wherein
the conductive member includes a first conductive member and a second conductive member spaced apart from the first conductive member, and
the through-hole includes a first through-hole accommodating the first conductive member and a second through-hole accommodating the second conductive member.

11. The battery cell of claim 8, wherein the conductive member includes a conductive foil connecting the first end portion to the second end portion and a heat dissipation member at least partially attached to the conductive foil.

12. The battery cell of claim 1, wherein the thermochromic member includes a base, at least one thermochromic region attached to the base, and an adhesive tape covering the at least one thermochromic region.

13. The battery cell of claim 12, wherein
the cap assembly includes a venting portion for discharging gas generated in the electrode assembly to the outside of the battery cell,
at least a portion of the thermochromic member passes through the venting portion, and
the at least one thermochromic region is exposed to the outside of the cap assembly.
